(19) United States
(12) Patent Application Publication
(10) Pub. No.: US 2004/0058083 A1
(43) Pub. Date: Mar. 25, 2004

(54) Coating system for producing color-and/or effect-imparting multilayer coatings on the basis of multi-component coating materials

(76) Inventors: Bernhard Lettmann, Drensteinfurt (DE); Egbert Nienhaus, Ascheberg (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/398,131

(22) PCT Filed: Sep. 26, 2001
(86) PCT No.: PCT/EP01/11105

(30) Foreign Application Priority Data
Sep. 30, 2000 (DE) 100 48 670.3

(51) Int. Cl. B05D 1/36; B05D 7/00

(52) U.S. Cl. 427/407.1; 427/402

(57) ABSTRACT

An integrated coating material system for producing multicoat color and/or effect coating systems on primed and unprimed substrates, comprising

(I) a multicomponent surfacer, comprising a constituent containing isocyanate-reactive groups, and fillers,

(II) a multicomponent topcoat material comprising a constituent containing isocyanate-reactive groups, color pigments, and polyisocyanate

(III) a multicomponent clearcoat material comprising at least one constituent containing isocyanate-reactive groups, and polyisocyanates

the same polyisocyanate and the same diluent being used throughout for producing the multicomponent coating materials, wherein said clearcoat material (III) comprises a solvent-containing multicomponent system curable thermally and with actinic radiation (dual cure) and comprising

(A) a component comprising

(A1) a constituent containing isocyanate-reactive functional groups,

(A2) a constituent containing isocyanate-reactive functional groups and at least one functional group having at least one bond which can be activated with actinic radiation, and

(B) a component comprising a polyisocyanate (B1).

The present invention relates to a novel solvent-containing coating material system for producing multicoat color and/or effect coating systems on the basis of multicomponent coating materials. The present invention further relates to the use of the novel coating material system for automotive OEM finishing, automotive refinishing, the coating of furniture, doors, windows or constructions in the interior and exterior sector, and also for industrial coating, including coil coating, container coating and the coating or impregnation of electrical components, but especially automotive refinishing.

Here and below, actinic radiation is electromagnetic radiation such as near infrared (NIR), visible light, UV radiation or x-rays, especially UV radiation, or corpuscular radiation such as electron beams.

Among those in the art, curing with heat and actinic radiation is also referred to for short as dual cure.

A dual-cure multicomponent system is known, for example, from European Patent Application EP 0 928 800 A1. It comprises a urethane (meth)acrylate containing free isocyanate groups and (meth)acryloyl groups, a photoinitiator and an isocyanate-reactive compound, especially a polyol or polyamine. A constituent which contains both isocyanate-reactive functional groups and functional groups having at least one bond which can be activated with actinic radiation is not used. Although this dual-cure coating material offers the possibility of varying the profiles of properties of coating material and coating and of tailoring them to different end uses, its flash-off time is still too long and its initial hardness in the shadow zones of three-dimensional substrates of complex shape, which are not reached by the actinic radiation without the use of relatively expensive apparatus, is too low. The patent application does not describe the preparation of an integrated coating material system for producing multicoat color and/or effect coating systems on the basis of multicomponent coating materials.

Moreover, dual-cure multicomponent systems are known from German Patent Application DE 198 18 735 A1. These systems necessarily comprise

compounds (A) having one or more free-radically polymerizable double bonds and further comprising at least one other functional group which is reactive in the sense of an addition reaction and/or condensation reaction, and

compounds (B) having one or more free-radically polymerizable double bonds and further comprising at least one other functional group which is reactive in the sense of an addition reaction and/or condensation reaction, the additional reactive functional group being complementary or reactive with respect to the additional reactive functional groups of the compounds (A).

In addition, they may comprise at least one monomeric, oligomeric and/or polymeric compound (C) having at least one functional group which is reactive in the sense of an addition reaction and/or condensation reaction with respect to the functional groups of the compounds (A) or (B) that are present in addition to the free-radically polymerizable double bonds.

The advantages set out in the patent application, which are purportedly possessed by all of the systems described therein, however, stop at general indications and are not reinforced by a specific example. Leaving this aside, there is no statement of the minimum amounts in which the additional reactive functional groups should be present in the compounds. The preparation of an integrated coating material system for producing multicoat color and/or effect coating systems on the basis of multicomponent coating materials is not described in the patent application.

Solvent-containing integrated coating material systems for producing multicoat color and/or effect coating systems on the basis of multicomponent coating materials are known per se. They comprise a multicomponent surfacer for producing a surfacer coat or antistonechip primer, a pigmented multicomponent topcoat material for producing a solid-color topcoat, and a multicomponent clearcoat material for producing a clearcoat, which may if appropriate be employed together with a customary and known color and/or effect basecoat material. For these known solvent-containing integrated coating material systems it is essential that the same curing agent and the same diluent are used throughout to produce the multicomponent surfacer, the pigmented multicomponent topcoat materials and the multicomponent clearcoat materials. This results in a particularly simple and reliable harmonization of the profiles of properties of the multicomponent coating materials of the integrated coating material system and of the coating systems produced therefrom.

Disadvantages of the known solvent-containing integrated coating systems, however, are that their clearcoat films have a comparatively high flash-off time and that the clearcoats produced from them have a low initial hardness. Moreover, the curing times are comparatively long.

The problem of the long curing time could be eliminated by using a clearcoat material curable with actinic radiation. However, owing to the known tendency of clearcoat materials curable with actinic radiation to shrink on curing, this would lead to problems of adhesion between clearcoat and any basecoat present. Moreover, it would be difficult materially to integrate such a clearcoat material into the solvent-containing coating material system.

Although the adhesion problems might be solved by the use of the known dual-cure clearcoat materials, this would not solve the problem of the lack of material integratability.

It is an object of the present invention to find a new solvent-containing coating material system for producing multicoat color and/or effect coating systems on primed and unprimed substrates, comprising a multicomponent surfacer for producing a surfacer coat or antistonechip primer, a pigmented multicomponent topcoat material for producing a solid-color topcoat, and a multicomponent clearcoat material for producing a clearcoat, the same curing agent and the same diluent being used throughout to produce the multicomponent surfacers, the pigmented multicomponent topcoat materials and the multicomponent clearcoat materials. The new integrated coating material system should no longer have the disadvantages of the prior art but should instead comprise a dual-cure clearcoat material which is materially integratable into the coating material system, has a short flash-off time following its application and a high initial hardness, so that it is not tacky even in the problematic shadow zones of complex three-dimensional substrates. Moreover, the resultant clearcoat should adhere firmly to any color and/or effect basecoat present.

Overall, the intention is that the multicoat color and/or effect coating system produced with the aid of the new integrated coating material system should exhibit an outstanding overall visual impression, high scratch resistance and very good chemical, gasoline, solvent and etch resistance and weathering stability, and no cracks.

Accordingly, we have found the novel integrated coating material system for producing multicoat color and/or effect coating systems on primed and unprimed substrates, comprising

(I) at least one multicomponent surfacer, comprising at least one component (A) comprising at least one constituent (A1) containing isocyanate-reactive groups and at least one filler, at least one component (B) comprising at least one polyisocyanate (B1) and a diluent (C), for producing at least one surfacer coat or antistonechip primer,

(II) at least one multicomponent topcoat material comprising at least one component (A) comprising at least one constituent (A1) containing isocyanate-reactive groups and at least one color pigment, at least one component (B) comprising at least one polyisocyanate (B1), and a diluent (C), for producing at least one solid-color topcoat, and

(III) at least one multicomponent clearcoat material comprising at least one component (A) comprising at least one constituent (A1) containing isocyanate-reactive groups, at least one component (B) comprising at least one polyisocyanate (B1), and a diluent (C),

the same polyisocyanate and the same diluent being used throughout for producing the multicomponent coating materials (I) to (III), wherein said clearcoat material (III) comprises a solvent-containing multicomponent system curable thermally and with actinic radiation (dual cure) and comprising

(A) at least one component comprising

(A1) at least one constituent containing isocyanate-reactive functional groups,

(A2) at least one constituent containing isocyanate-reactive functional groups and at least one functional group having at least one bond which can be activated with actinic radiation,

(B) at least one component comprising at least one polyisocyanate (B1), and

(C) a diluent.

In the text below, the novel solvent-containing integrated coating material system for producing multicoat color and/or effect coating systems is referred to as the “coating material system of the invention”.

The essential constituent of the coating material system of the invention is the dual-cure clearcoat material (III). It is a solvent-containing multicoat system curable thermally and with actinic radiation.

The dual-cure clearcoat material (III) comprises at least one, especially one, component (A). This component in turn comprises at least one, especially one, constituent (A1) containing isocyanate-reactive functional groups. The amount of isocyanate-reactive functional groups may vary widely; it is preferred to use at least 1.8, preferably at least 2.0, and in particular at least 2.1 meq/g constituent (A1).

Examples of suitable isocyanate-reactive functional groups are thiol, primary or secondary amino, imino or hydroxyl groups, especially hydroxyl groups.

The constituent (A1) may be of low molecular masse oligomeric or polymeric. Preferably it is oligomeric or polymeric.

The basic structures of the low molecular mass constituents (A1) are not critical but instead may derive from any of a very wide variety of organic compound classes. Examples of suitable classes of compound are alkyl, cycloalkyl, alkylcycloalkyl, cycloalkylalkyl, aryl, alkylaryl, cycloalkylaryl, arylalkyl and/or arylcycloalkyl compounds with or without heteroatoms such as oxygen, nitrogen, sulfur, silicon or phosphorus and optionally carrying further substituents which, however, must not react during the preparation of the constituents, their storage and/or their use with the bonds which can be activated with actinic radiation.

The basic structures of the oligomeric or polymeric constituents (A1) are likewise not critical and may derive from any of a wide variety of oligomer and polymer classes. Examples of suitable oligomer and polymer classes are random, alternating and/or block linear and/or branched and/or comb (co)polymers of ethylenically unsaturated monomers, or polyaddition resins and/or polycondensation resins. Regarding these terms, reference is made for further details to Römpp Lexikon Lacke und Druckfarben, Georg Thieme Verlag, Stuttgart, New York, 1998, page 457, “Polyaddition” and “Polyaddition resins (polyadducts)”, and also pages 463 and 464, “Polycondensates”, “Polycondensation” and “Polycondensation resins”. As regards any substituents which may be present, the remarks made above apply accordingly.

Examples of highly suitable (co)polymers (A1) are poly(meth)acrylates and partially hydrolyzed polyvinyl esters.

Examples of highly suitable polyaddition resins and/or polycondensation resins (A1) are polyesters, alkyds, polyurethanes, polylactones, polycarbonates, polyethers, epoxy resin-amine adducts, polyureas, polyamides or polyimides.

Also suitable are the graft copolymers of the above-described oligomers and polymers, such as for example, (meth)acrylate copolymer-polyester, -polyurethane or -epoxy resin graft copolymers.

In accordance with the invention, the (meth)acrylate copolymers or their graft copolymers, especially those containing hydroxyl groups, have particular advantages and in accordance with the invention are used with particular preference as constituents (A1).

The (meth)acrylate copolymers (A1) are polymers which are known per se. Their preparation has no special features as to method but instead takes place with the aid of the methods customary and known in the plastics field of the continuous or discontinuous free-radically initiated copolymerization in bulk, solution, emulsion, miniemulsion or microemulsion under atmospheric pressure or superatmospheric pressure in stirred vessels, autoclaves, tube reactors, loop reactors or Taylor reactors at temperatures from 50 to 200° C.

Examples of suitable (meth)acrylate copolymers (A1) and copolymerization methods are described in patent applications DE 197 09 465 A1, DE 197 09 476 A1, DE 28 48 906 A1, DE 195 24 182 A1, DE 198 28 742-A1, DE 196 28 143 A1, DE 196 28 142 A1, EP 0 554 783 A1, WO 95/27742, WO 82/02387 and WO 98/02466.

In component (A), the constituents (A1) are present in widely varying amounts. Preferably, the component comprises the constituents (A1) in an amount of from 5 to 80, more preferably from 6 to 70 and in particular from 7 to 60% by weight, based in each case on component (A).

Additionally, component (A) comprises at least one, especially one, constituent (A2) containing isocyanate-reactive functional groups and at least one, preferably at least two and in particular three, functional groups having at least one bond which can be activated with actinic radiation. The amount of isocyanate-reactive functional groups may vary widely; preferably, at least 1.8, more preferably at least 2.0 and in particular at least 2.1 meq/g constituent (A2) are used.

Examples of suitable bonds which can be activated with actinic radiation are carbon-hydrogen single bonds or carbon-carbon, carbon-oxygen, carbon-nitrogen, carbon-phosphorus or carbon-silicon single bonds or double bonds. Of these, the double bonds, especially the carbon-carbon double bonds (“double bonds”), are employed with preference.

Very suitable double bonds are present, for example, in (meth)acrylate, ethacrylate, crotonate, cinnamate, vinyl ether, vinyl ester, ethenylarylene, dicyclopentadienyl, norbornenyl, isoprenyl, isopropenyl, allyl or butenyl groups; ethenylarylene ether, dicyclopentadienyl ether, norbornenyl ether, isoprenyl ether, isopropenyl ether, allyl ether or butenyl ether groups; or ethenylarylene ester, dicyclopentadienyl ester, norbornenyl ester, isoprenyl ester, isopropenyl ester, allyl ester or butenyl ester groups. Of these, (meth)acrylate groups, especially acrylate groups, are of particular advantage and are therefore used with very particular preference in accordance with the invention.

The constituent (A2) may be of low molecular mass, oligomeric or polymeric. Preferably it is oligomeric or polymeric.

The basic structure of the constituent (A2) is not critical. It is possible to use the basic structures described above for the constituent (A1).

Accordingly, the constituents (A2) come in particular from the oligomer and/or polymer classes of the (meth)acryloyl-functional (meth)acrylate copolymers, polyether acrylates, polyester acrylates, epoxy acrylates, urethane acrylates, amino acrylates, melamine acrylates, silicone acrylates and phosphazene acrylates and the corresponding methacrylates. It is preferred to use binders (A2) which are free from aromatic structural units. Use is therefore made preferably of urethane (meth)acrylates, phosphazene (meth)acrylates and/or polyester (meth)acrylates, with particular preference of urethane (meth)acrylates, especially aliphatic urethane (meth)acrylates.

The preparation of urethane (meth)acrylate (A2) having terminal and/or lateral double bonds has no special features in terms of its method but instead is described in detail in patent applications and patents DE 196 45 761 A, WO 98/10028, EP 0 742 239 A1, EP 0 661 321 B1, EP 0 608 021 B1, EP 0 447 998 B1, and EP 0 462 287 B. Moreover, these constituents are commercially customary products and are sold, for example, under the brand name Rahn® 99-664 by the company Rahn.

In component (A), the constituents (A2) are present in widely varying amounts. Preferably, component (A) comprises the constituents (A2) in an amount of from 10 to 60, more preferably from 15 to 55, and in particular from 20 to 50% by weight, based in each case on component (A).

Furthermore, component (A) of the multicomponent system may further comprise customary and known additives in effective amounts. The essential factor is that the additives do not inhibit or prevent entirely the dual-cure crosslinking reactions.

Examples of suitable additives are nanoparticles, reactive diluents curable thermally or with actinic radiation, low-boiling organic solvents and high-boiling organic solvents (“long solvents”), water, UV absorbers, light stabilizers, free-radical scavengers, thermally labile free-radical initiators, photoinitiators and photocoinitiators, crosslinking agents as used in one-component systems, thermal crosslinking catalysts, devolatilizers, slip additives, polymerization inhibitors, defoamers, emulsifiers, wetting agents, dispersants, adhesion promoters, levelling agents, film-forming auxiliaries, sag control agents (SCAs), rheology control additives (thickeners), flame retardants, siccatives, dryers, antiskinning agents, corrosion inhibitors, waxes, flatting agents, precursors of organically modified ceramic materials, or additional binders.

Examples of suitable thermally curable reactive diluents are positionally isomeric diethyloctanediols or hydroxyl-containing hyperbranched compounds or dendrimers, as described for example in German Patent Applications DE 198 05 421 A1, DE 198 09 643 A1, and DE 198 40 405 A1.

Examples of suitable reactive diluents curable with actinic radiation are those described in Römpp Lexikon Lacke und Druckfarben, Georg Thieme Verlag, Stuttgart, N.Y., 1998, on page 491 under the entry “reactive diluents” or in column 7 lines 1 to 26 of DE 198 18 715 A1, or reactive diluents having at least 5, especially 5, bonds which can be activated with actinic radiation in their molecule, such as dipentaerythritol pentacrylate, for example.

Examples of suitable low-boiling organic solvents and high-boiling organic solvents (“long solvents”) are ketones such as methyl ethyl ketone, methyl isoamyl ketone or methyl isobutyl ketone, esters such as ethyl acetate, butyl acetate, ethyl ethoxypropionate, methoxypropyl acetate or butyl glycol acetate, ethers such as dibutyl ether or ethylene glycol, diethylene glycol, propylene glycol, dipropylene glycol, butylene glycol or dibutylene glycol dimethyl, diethyl or dibutyl ether, N-methylpyrrolidone or xylenes or mixtures of aromatic and/or aliphatic hydrocarbons such as Solventnaphtha®, mineral spirit 135/180, dipentenes or Solvesso®.

Examples of suitable thermally labile free-radical initiators are organic peroxides, organic azo compounds or C—C-cleaving initiators such as dialkyl peroxides, peroxocarboxylic acids, peroxodicarbonates, or peroxide esters, hydroperoxides, ketone peroxides, azo dinitriles or benzpinacol silyl ethers.

Examples of suitable crosslinking catalysts are dibutyltin dilaurate, dibutyltin dioleate, lithium decanoate, zinc octoate or bismuth salts such as bismuth lactate or bismuth dimethylolpropionate.

Examples of suitable photoinitiators and coinitiators are described in Römpp Lexikon Lacke und Druckfarben, Georg Thieme Verlag, Stuttgart, 1998, pages 444 to 446.

Examples of suitable additional crosslinking agents as used in one-component systems are amino resins, as described for example in Römpp Lexikon Lacke und Druckfarben, Georg Thieme Verlag, 1998, page 29, “Amino resins”, in the text book “Lackadditive” [Additives for Coatings] by Johan Bieleman, Wiley-VCH, Weinheim, N.Y., 1998, pages 242 ff., in the book “Paints, coatings and solvents”, second, completely revised edition, D. Stoye and W. Freitag (eds.), Wiley-VCH, Weinheim, N.Y., 1998, pages 80 ff., in patents U.S. Pat. No. 4,710,542 A1 and EP-B-0 245 700 A1, and in the article by B. Singh and coworkers, “Carbamylmethylated Melamines, Novel Crosslinkers for the Coatings Industry” in Advanced Organic Coatings Science and Technology Series, 1991, Volume 13, pages 193 to 207; carboxyl-containing compounds or resins, as described for example in patent DE 196 52 813 A1; resins or compounds containing epoxide groups, as described for example in patents EP 0 299 420 A1, DE 22 14 650 B1, DE 27 49 576 B1, U.S. Pat. No. 4,091,048 A and U.S. Pat. No. 3,781,379 A; blocked polyisocyanates, as described for example in patents U.S. Pat. No. 4,444,954 A, DE 196 17 086 A1, DE 196 31 269 A1, EP 0 004 571 A1 and EP 0 582 051 A1; and/or tris(alkoxycarbonylamino)triazines as described in patents U.S. Pat. No. 4,939,213 A, U.S. Pat. No. 5,084,541 A, U.S. Pat. No. 5,288,865 A and EP 0 604 922 A1.

Examples of suitable devolatilizers are diazadicycloundecane and benzoin.

Examples of suitable emulsifiers are nonionic emulsifiers, such as alkoxylated alkanols, polyols, phenols and alkylphenols, or anionic emulsifiers such as alkali metal salts or ammonium salts of alkanecarboxylic acids, alkanesulfonic acids, and sulfo acids of alkoxylated alkanols, polyols, phenols and alkylphenols.

Examples of suitable wetting agents are siloxanes, fluorine compounds, carboxylic monoesters, phosphoric esters, polyacrylic acids and their copolymers, or polyurethanes.

An example of a suitable adhesion promoter is tricyclodecanedimethanol.

Examples of suitable film-forming auxiliaries are cellulose derivatives such as cellulose acetobutyrate (CAB).

Examples of suitable transparent fillers are those based on silicon dioxide, aluminum oxide or zirconium oxide; for further details, reference is made to Römpp Lexikon Lacke und Druckfarben, Georg Thieme Verlag, Stuttgart, 1998, pages 250 to 252.

Examples of suitable Sag control agents are ureas, modified ureas and/or silicas, as described for example in the literature references EP 0 192 304 A1, DE 23 59 923 A1, DE 18 05 693 A1, WO 94/22968, DE 27 51 761 C1, WO 97/12945 or “farbe+lack”, 11/1992, pages 829 ff.

Examples of suitable rheology control additives are those known from patents WO 94/22968, EP 0 276 501 A1, EP 0 249 201 A1 and WO 97/12945; crosslinked polymeric microparticles, as disclosed for example in EP 0 008 127 A1; inorganic phyllosilicates such as aluminum-magnesium silicates, sodium-magnesium and sodium-magnesium-fluorine-lithium phyllosilicates of the montmorillonite type; silicas such as Aerosils; or synthetic polymers containing ionic and/or associative groups such as polyvinyl alcohol, poly(meth)acrylamide, poly(meth)acrylic acid, polyvinylpyrrolidone, styrene-maleic anhydride copolymers or ethylene-maleic anhydride copolymers and their derivatives or hydrophobically modified ethoxylated urethanes or polyacrylates.

An example of a suitable flatting agent is magnesium stearate.

Examples of suitable precursors of organically modified ceramic materials are hydrolyzable organometallic compounds, especially of silicon and aluminum.

Further examples of the above-listed additives and also examples of suitable UV absorbers, free-radical scavengers, levelling agents, flame retardants, siccatives, dryers, antiskinning agents, corrosion inhibitors and waxes (B) are described in detail in the text book “Lackadditive” by Johan Bieleman, Wiley-VCH, Weinheim, N.Y., 1998.

The preparation of component (A) for use in accordance with the invention has no special features but instead takes place in a customary and known manner by mixing of the above-described constituents in appropriate mixing equipment such as stirred vessels, dissolvers, stirred mills or extruders.

Component (B) of the dual-cure clearcoat material (III) comprises at least one polyisocyanate (B1).

The polyisocyanates (B1) contain on average at least 2.0, preferably more than 2.0, and in particular more than 3.0 isocyanate groups per molecule. Basically, there is no upper limit on the number of isocyanate groups; in accordance with the invention, however, it is of advantage if the number does not exceed 15, preferably 12, with particular preference 10, with very particular preference 8.0, and in particular 6.0.

Examples of suitable polyisocyanates (B1) are isocyanato-containing polyurethane prepolymers which may be prepared by reacting polyols with an excess of diisocyanates and are preferably of low viscosity.

Examples of suitable diisocyanates are isophorone diisocyanate (i.e., 5-isocyanato-1-isocyanatomethyl-1,3,3-trimethylcyclohexane), 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)-cyclohexane, 1-isocyanato-2-(3-isocyanatoeth-1-yl)cyclohexane, 1-isocyanato-2-(4-isocyanatobut-1-yl)-cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane 2,4′-diisocyanate, trimethylene diisocyanate, tetramethylene diisocyanate, pentamethylene diisocyanate, hexamethylene diisocyanate (HDI), ethylethylene diisocyanate, trimethylhexane diisocyanate, heptamethylene diisocyanate or diisocyanates derived from dimeric fatty acids, as sold under the commercial designation DDI 1410 by the company Henkel and described in patents WO 97/49745 and WO 97/49747, especially 2-heptyl-3,4-bis(9-isocyanatononyl)-1-pentylcyclohexane, or 1,2-, 1,4- or 1,3-bis(isocyanatomethyl)cyclohexane, 1,2-, 1,4- or 1,3-bis(2-isocyanatoeth-1-yl)cyclohexane, 1,3-bis(3-isocyanatopropy-1-yl)cyclohexane, 1,2-, 1,4- or 1,3-bis(4-isocyanatobut-1-yl)cyclohexane or liquid bis(4-isocyanatocyclohexyl)methane with a trans/trans content of up to 30% by weight, preferably 25% by weight and in particular 20% by weight, as described in patent applications DE 44 14 032 A1, GB 1220717 A1, DE 16 18 795 A1 and DE 17 93 785 A1, preferably isophorone diisocyanate, 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane or HDI, especially HDI.

It is also possible to use polyisocyanates (B1) containing isocyanurate, biuret, allophanate, iminooxadiazinedione, urethane, urea, carbodiimide and/or uretdione groups, which are prepared in a customary and known manner from the diisocyanates described above. Examples of suitable preparation techniques and polyisocyanates are known, for example, from patents CA 2,163,591 A, U.S. Pat. No. 4,419,513, U.S. Pat. No. 4,454,317 A, EP 0 646 608 A, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A1, U.S. Pat. No. 5,290,902 A1, EP 0 649 806 A1, DE 42 29 183 A1 and EP 0 531 820 A1.

The amount of the polyisocyanates (B1) in component (B) may vary widely. Primarily it is guided by the viscosity necessary for mixing with the other components. Preferably, the amount is from 20 to 80, more preferably from 30 to 70, and in particular from 35 to 65% by weight, based on component (B). Component (B) preferably further comprises at least one of the above-described organic solvents.

Preparation of component (B) has no special features in terms of its method but instead takes place by the mixing of its constituents. In order to establish a low viscosity, component (B) may further be admixed with at least one of the above-described organic solvents.

Where the dual-cure clearcoat material (III) for use in accordance with the invention comprises only components (A) and (B), it constitutes a two-component system. However, different constituents of the individual components (A) and/or (B) may be stored separately from these components and combined not until shortly before application to form the dual-cure clearcoat material (III). In general, the two-component system is preferred since it entails less effort for its preparation.

The preparation of the dual-cure clearcoat material (III) from the above-described components (A) and (B) has no special features in terms of its method but instead is carried out with the aid of the customary and known, above-described mixing equipment and mixing techniques or by means of customary two-component or multicomponent metering and mixing units. Ideally, mixing takes place by hand if permitted by the viscosity of components (A) and (B).

The volume ratio of component (A) to component (B) may vary widely. It is guided primarily by the functionality and concentration of the above-described reactive constituents of the components, especially (A1) and (A2) on the one hand and (B1) on the other hand. The skilled worker will therefore easily be able to determine the optimum volume ratio for each individual case on the basis of his or her knowledge of the art, with or without the assistance of simple rangefinding tests. The volume ratio is preferably from 10:1 to 1:3, more preferably from 8:1 to 1:2.7, and in particular from 6:1 to 1:2.5.

Prior to their application, a diluent (C) is added to the dual-cure clearcoat materials (III) described above. The diluent (C) comprises at least one organic solvent; preferably, at least two, more preferably at least three, with particular preference at least four, with very particular preference at least five, and in particular at least six organic solvents are used. Examples of suitable solvents are those described above for the additives, especially xylene, Solventnaphtha, mineral spirit 135/180, methoxypropyl acetate, butyl acetate, butyl glycol acetate, ethyl ethoxypropionate and/or dipentenes. The diluent (C) may be employed in different amounts. They are guided in particular by the application viscosity which is to be established and in accordance with the desired leveling properties. Preferably, the diluent (C) is used in an amount of from 5 to 40, more preferably from 6 to 35, and in particular from 7 to 30 parts by weight per 100 parts by volume of components (A) and (B).

The addition of the diluent (C) has no special features in terms of its method but instead takes place in accordance with the above-described mixing methods. The diluent (C) is added during or after the mixing of components (A) and (B).

The coating material system of the invention further comprises at least one, especially one, multicomponent surfacer (I), comprising at least one, especially one, component (A) comprising at least one constituent (A1) containing isocyanate-reactive groups and at least one filler, at least one, especially one, component (B) comprising at least one polyisocyanate (B1), and a diluent (C), for producing at least one surfacer coat or antistonechip primer.

Component (A) comprises at least one constituent. (A1) containing isocyanate-reactive groups. Suitable constituents (A1) are the above-described oligomeric and polymeric constituents (A1). These need not necessarily be identical with the constituents (A1) of the multicomponent topcoat material (II) or of the dual-cure clearcoat material (III), but instead may be adapted to the specific requirements of surfacers and antistonechip primers. Preference is given to the use of (meth)acrylate copolymers whose lateral carboxyl groups have been esterified with epoxides or whose lateral epoxide groups have been esterified with carboxylic acids, so resulting in additional hydroxyl groups. An especially suitable (meth)acrylate copolymer of this kind is sold under the brand name Synthalat® A200 of the company Synthopol Chemie.

The amount of the constituent (A1) in component (A) may vary widely. Preferably it is from 5 to 50, more preferably from 6 to 45, and in particular from 7 to 40% by weight, based in each case on component (A).

Component (A) of the multicomponent surfacer (I) further comprises customary and known fillers and pigments, the pigments generally being not effect pigments but only color pigments. Particularly suitable are pigments which provide achromatic color. Also suitable are color pigments as present in the multicomponent basecoat material (II).

The color pigments may comprise organic or inorganic pigments. Examples of suitable pigments are naturally occurring pigments (cf. Römpp Lexikon Lacke und Druckfarben, Georg Thieme Verlag, Stuttgart, N.Y., pages 400 and 467, “Naturally occuring pigments”), synthetic iron oxide pigments, titanium dioxide pigments, polycyclic pigments (cf. Römpp Lexikon Lacke und Druckfarben, page 459 “Polycyclic pigments”), azomethine pigments, azo pigments (cf. Römpp Lexikon Lacke und Druckfarben, page 52, “Azomethine pigments”, “Azo pigments”) or metal complex pigments (cf. Römpp Lexikon Lacke und Druckfarben, page 379, “Metal complex pigments”).

Examples of suitable organic and inorganic fillers are chalk, calcium sulfates, barium sulfate, silicates such as talc or kaolin, silicas, oxides such as aluminum hydroxide or magnesium hydroxide, or organic fillers such as textile fibers, cellulose fibers, polyethylene fibers or finely divided powders comprising spherical polymer particles. For further details, reference is made to Römpp Lexikon Lacke und Druckfarben, Georg Thieme Verlag, 1998, pages 250 ff., “Fillers”.

In component (A) of the multicomponent surfacer (I), the pigments and fillers are present in widely varying amounts. They are preferably present in an amount, based in each case on component (A), of from 20 to 80, more preferably from 25 to 70, and in particular from 30 to 60% by weight.

Furthermore, component (A) of the multicomponent surfacer (I) may comprise the additives described above in connection with the dual-cure clearcoat material (III).

The multicomponent surfacer (I) comprises at least one, especially one, component (B) comprising at least one, especially one, polyisocyanate (B1). It is essential that the polyisocyanates (B1) used are the same as those used in components (B) of the multicomponent basecoat material (II) and of the dual-cure clearcoat material (III).

Preferably, component (B) further comprises at least one of the above-described organic solvents in order to reduce the viscosity of component (B) for purposes of improved miscibility. Preferably, the solvents used are the same as in components (B) of the multicomponent topcoat material (II) and of the dual-cure clearcoat material (III).

Further advantages result if in component (B) the polyisocyanates (B1) and the organic solvents are present in the same amounts in which they are present in components (B) of the multicomponent topcoat material (II) and of the dual-cure clearcoat material (III).

As far as the volume ratio of component (A) to component (B) is concerned, the comments made above for the dual-cure clearcoat material (III) apply here accordingly.

The multicomponent surfacer (I) further comprises the same diluent (C) as also present in the multicomponent topcoat material (II) and in the dual-cure clearcoat material (III). In this case it is not necessary to use the same amount of diluents (C) as for the multicomponent topcoat material (II) and the dual-cure clearcoat material (III); instead, the amounts may be adapted to the specific requirements of surfacers or antistonechip primers.

The coating material system as shown in the invention further comprises at least one, especially one, multicomponent topcoat material (II) comprising at least one, especially one, component (A) comprising at least one constituent (A1) containing isocyanate-reactive groups and at least one color and/or effect pigment, at least one, especially one, component (B) comprising at least one, especially one, polyisocyanate (B1) and at least one diluent (C), for producing at least one, especially one, solid-color topcoat (II).

Component (A) comprises at least one constituent (A1) containing isocyanate-reactive groups. Suitable constituents (A1) are the above-described oligomeric and polymeric constituents (A1). These need not necessarily be identical with the constituents (A1) of the multicomponent surfacer (I) or of the dual-cure clearcoat material (III), but instead may be adapted to the specific requirements of solid-color topcoats. It is preferred to use (meth)acrylate copolymer-polyester graft copolymers.

The amount of constituent (A1) in component (A) may vary very widely. Preferably it is from 20 to 95, more preferably from 25 to 90, and in particular from 30 to 90% by weight, based in each case on component (A).

Component (A) of the multicomponent topcoat material (II) further comprises customary and known color and/or effect, but especially color, pigments.

The color pigments comprise those described above in connection with the multicomponent surfacer (I).

Where used, suitable effect pigments are metal flake pigments such as commercially customary aluminum bronzes, aluminum bronzes chromated in accordance with DE 36 36 183 A1, and commercially customary stainless steel bronzes, and also nonmetallic effect pigments, such as pearlescent pigments and interference pigments, for example. For further details, reference is made to Römpp Lexikon Lacke und Druckfarben, Georg Thieme Verlag, 1998, pages 176, “Effect pigments” and pages 380 and 381 “Metal oxide-mica pigments” to “Metal pigments”, or to patents and patent applications DE 36 36 156 A1, DE 37 18 446 A1, DE 37 19 804 A1, DE 39 30 601 A1, EP 0 068 311 A1, EP 0 264 843 A1, EP 0 265 820 A1, EP 0 283 852 A1, EP 0 293 746 A1, EP 0 417 567 A1, U.S. Pat. No. 4,828,826 A and U.S. Pat. No. 5,244,649 A.

The pigments in component (A) of the multicomponent topcoat material (II) are present in widely varying amounts, which are guided primarily by the hiding power of the pigments. They are preferably present in an amount, based in each case on component (A), of from 1 to 30, more preferably from 2 to 25, and in particular from 3 to 20% by weight.

Furthermore, component (A) of the multicomponent topcoat material (II) may comprise the additives described above in connection with the dual-cure clearcoat material (III).

The multicomponent topcoat material (II) comprises at least one, especially one, component (B) comprising at least one, especially one, polyisocyanate (B1). It is essential that the polyisocyanates (B1) used are the same as those used in components (B) of the multicomponent surfacer (I) and of the dual-cure clearcoat material (III).

Preferably, component (B) comprises at least one of the above-described organic solvents in order to reduce the viscosity of component (B) for purposes of improved miscibility. Preferably, the solvents used are the same as in component (B) of the multicomponent surfacer (I) and of the dual-cure clearcoat material (III).

Further advantages result if in component (B) the polyisocyanates (B1) and the organic solvents are present in the same amounts as in components (B) of the multicomponent surfacer (I) and of the dual-cure clearcoat material (III).

As far as the volume ratio of component (A) to component (B) is concerned, the comments made above in relation to the dual-cure clearcoat material (III) apply here accordingly.

The multicomponent topcoat material (II) further comprises the same diluent (C) as also present in the multicomponent surfacer (I) and in the dual-cure clearcoat material (III). In this case it is not necessary to use the same amounts of diluent (C) as in the multicomponent surfacer (I) and the dual-cure clearcoat material (III); instead, the amounts may be adapted to the specific requirements of solid-color topcoat materials and solid-color topcoats.

In terms of method, the application of the individual coating materials of the coating material system of the invention has no special features but instead may take place by any customary application method, such as spraying, knifecoating, brushing, flowcoating, dipping, trickling or rolling, for example. It is preferred to employ spray application methods, such as compressed air spraying, airless spraying, high-speed rotation, electrostatic spray application (ESTA), alone or in conjunction with hot spray applications such as hot-air spraying, for example.

Suitable substrates are surfaces which are not damaged by curing of the coating materials present thereon using heat and actinic radiation; examples are metals, plastics, wood, ceramic, stone, textile, fiber composites, leather, glass, glass fibers, glass wool, rockwool, mineral-bound and resin-bound building materials, such as plasterboard and cement slabs or roof tiles, and also assemblies of these materials.

Accordingly, the coating material system of the invention is also suitable for applications outside of automotive OEM finishing and automotive refinishing. In this context it is particularly suitable for the coating of furniture, windows, doors, constructions in the interior and exterior sector, and for industrial coating, including coil coating, container coating and the impregnation or coating of electrical components. In the context of industrial coatings, it is suitable for coating virtually all parts for private or industrial use, such as radiators, domestic appliances, small metal parts such as nuts and bolts, wheel caps, wheel rims, packaging, or electrical components such as motor windings or transformer windings. In particular, however, the coating material system of the invention is suitable for automotive refinishing.

In the case of electrically conductive substrates, it is possible to use primers which are produced in a customary and known manner from the electrodeposition coating materials. Both anodic and cathodic electrodeposition coating materials are suitable for this purpose, but especially cathodic materials.

It is also possible to coat primed or unprimed plastics parts made, for example, from ABS, AMMA, ASA, CA, CAB, EP, UF, CF, MF, MPF, PF, PAN, PA, PE, HDPE, LDPE, LLDPE, UHMWPE, PC, PC/PBT, PC/PA, PET, PMMA, PP, PS, SB, PUR, PVC, RF, SAN, PBT, PPE, POM, PUR-RIM, SMC, BMC, PP-EPDM and UP (abbreviated codes in accordance with DIN 7728P1). Unfunctionalized and/or nonpolar substrate surfaces may be subjected prior to coating in a known manner to a pretreatment, such as by plasma or by flaming, or may be provided with a primer.

Where the coating material system of the invention is used for automotive refinishing, the substrates are already coated with the automotive OEM finishes.

In general, the surfacer film (I), topcoat film (II) and clearcoat film (III) are applied in a wet film thickness such that curing thereof results in coats having the film thicknesses advantageous and necessary for their functions. In the case of the surfacer film this film thickness is from 10 to 150, preferably from 15 to 120, with particular preference from 20 to 100, and in particular from 25 to 90 μm, in the case of the solid-color topcoat film the film thickness is from 10 to 150, preferably from 15 to 120, with particular preference from 20 to 100, and in particular from 25 to 90 μm, and in the case of the clearcoat it is from 10 to 100, preferably from 15 to 90, with particular preference from 20 to 80, and in particular from 25 to 70 μm.

The clearcoat film (III) is preferably used in conjunction with a basecoat film based on a physically curing basecoat material which provides a color and/or effect basecoat. Suitable basecoat materials are known from patent applications EP 0 089 497 A1, EP 0 256 540 A1, EP 0 260 447 A1, EP 0 297 576 A1, WO 96/12747, EP 0 523 610 A1, EP 0 228 003 A1, EP 0 397 806 A1, EP 0 574 417 A1, EP 0 531 510 A1, EP 0 581 211 A1, EP 0 708 788 A1, EP 0 593 454 A1, DE-A-43 28 092 A1, EP 0 299 148 A1, EP 0 394 737 A1, EP 0 590 484 A1, EP 0 234 362 A1, EP 0 234 361 A1, EP 0 543 817 A1, WO 95/14721, EP 0 521 928 A1, EP 0 522 420 A1, EP 0 522 419 A1, EP 0 649 865 A1, EP 0 536 712 A1, EP 0 596 460 A1, EP 0 596 461 A1, EP 0 584 818 A1, EP 0 669 356 A1, EP 0 634 431 A1, EP 0 678 536 A1, EP 0 354 261 A1, EP 0 424 705 A1, WO 97/49745, WO 97/49747, EP 0 401 565 A1, EP 0 496 205 A1, EP 0 358 979 A1, EP 469 389 A1, DE 24 46 442 A1, DE 34 09 080 A1, DE 195 47 944 A1, DE 197 41 554.7 A1 and EP 0 817 684, column 5, lines 31 to 45.

The film thickness of the basecoat is from 5 to 50, preferably from 6 to 40, with particular preference from 7 to 30, and in particular from 8 to 25 μm.

After the surfacer film (I) has been applied it may be flashed off or cured thermally to completion. Prior to the application of the topcoat film (II), the resultant thermally cured surfacer coat (I) may be sanded and/or polished. This is especially the case in the context of automotive refinishing.

The applied topcoat film (II) may likewise be flashed off or cured thermally to completion before, if appropriate, the clearcoat film (III) is applied. If desired, the topcoat film may be cured together with the surfacer film (I) and/or with any clearcoat film (III) that may be present. In general, however, clearcoat materials (III) are not employed when using topcoat materials (II).

Alternatively, the coating system of the invention may be employed such that following application and curing of the surfacer film (I) a basecoat film and a clearcoat film (III) are applied wet-on-wet, after which the clearcoat film (III) is cured thermally and with actinic radiation.

The thermal curing of the surfacer film (I) and of the topcoat film (II) has no special features in terms of method or apparatus but instead takes place at room temperature or, if shorter cure times are desired, at higher temperatures, as described below for the thermal curing of the dual-cure clearcoat film (III).

The complete curing of the clearcoat film (III) of the coating material system of the invention takes place after a certain flash-off time. This is used for example, for leveling and for the degassing of the applied films or for the evaporation of volatile constituents such as solvents. The flash-off time may be assisted and/or shortened by the use of elevated temperatures up to 40° C. and/or by blowing, provided this does not entail any damage or alteration to the applied films, such as premature complete crosslinking, for example. The dual-cure clearcoat films (III) for use in accordance with the invention have an advantageously short flash-off time of <10, especially <6 minutes. This produces a shortening in the process times overall.

The curing takes place with actinic radiation, especially with UV radiation, and/or electron beams. If desired, it may be supplemented by or carried out with actinic radiation from other radiation sources. In the case of electron beams, it is preferred to operate under an inert gas atmosphere. This may be ensured, for example, by supplying carbon dioxide and/or nitrogen directly to the surface of the applied films.

In the case of curing with UV radiation as well it is possible to operate under inert gas in order to prevent the formation of ozone.

Curing with actinic radiation is carried out using the customary and known radiation sources and optical auxiliary measures. Examples of suitable radiation sources are high or low pressure mercury vapor lamps, with or without lead doping in order to open up a radiation window of up to 405 nm, or electron beam sources. Their arrangement is known in principle and may be adapted to the circumstances of the workpiece and the process parameters. In the case of workpieces of complex shape such as automobile bodies, the regions not accessible by direct radiation (shadow regions) such as cavities, folds and other structural undercuts may be cured using point, small-area or all-round sources, in conjunction with an automatic movement device for the irradiation of cavities or edges.

The equipment and conditions for these curing methods are described, for example, in R. Holmes, U. V. and E. B. Curing Formulations for Printing Inks, Coatings and Paints, SITA Technology, Academic Press, London, United Kingdom 1984.

The cure may be effected in stages, i.e., by multiple exposure to light or actinic radiation. This can also be done alternatingly, i.e., by curing in alternation with UV radiation and electron beams.

Thermal curing as well has no special features in terms of method but instead takes place in accordance with the customary and known methods such as heating in a forced air oven or irradiation with IR lamps. As for curing with actinic radiation, thermal curing may also take place in stages. Thermal curing is preferably effected at room temperature or above room temperature, preferably at temperatures >40° C., preferably >50° C., for a period of from one minute to several days.

Thermal curing and curing with actinic radiation may be used simultaneously or in alternation. Where the two curing methods are used in alternation, it is possible, for example, to commence with thermal curing and end with actinic radiation curing. In other cases, it may prove advantageous to commence and to end with actinic radiation curing. The skilled worker is able to determine the curing method which is most advantageous for the particular case in hand, on the basis of his general knowledge of the art with the assistance, if appropriate, of simple preliminary tests.

It is a significant advantage of the coating material system of the invention that it can be used to produce multicoat color and/or effect coating systems more rapidly than using conventional coating material systems. Owing to the particularly advantageous properties of the dual-cure clearcoat material (III), the multicoat color and/or effect coating systems of the invention possess a high initial hardness, even in the problematic shadow zones of three-dimensional substrates of complex shape.

Furthermore, the multicoat color and/or effect coating systems of the invention possess high hardness, flexibility, and chemical resistance, outstanding leveling, no runs, very good intercoat adhesion, an outstanding overall appearance, very good weathering stability, very high scratch resistance and abrasion resistance, and also very good polishability. Their intercoat adhesion and their adhesion to the substrates, especially their adhesion to an original finish, are outstanding.

### EXAMPLES

### Preparation Example 1

The Preparation of a Thermally Curable Methacrylate Copolymer (A1)

A steel reactor equipped with stirrer, reflux condenser and two feed vessels was charged with 185.6 parts by weight of ethyl epoxypropionate and this initial charge was heated with stirring to 160° C. Subsequently, a monomer mixture of 114.1 parts by weight of styrene, 136.9 parts by weight of methyl methacrylate, 79.3 parts by weight of butyl methacrylate, 109 parts by weight of n-butyl acrylate and 164.1 parts by weight of hydroxyethyl methacrylate was metered in at a uniform rate over the course of four hours. Beginning at the same time and in parallel with this monomer mixture, an initiator mixture of 35.8 parts by weight of ethyl ethoxypropionate and 36.2 parts by weight of di-tert-butyl peroxide was metered in at a uniform rate. After one hour, initiation was repeated at 110° C. with an initiator mixture of 5.7 parts by weight of butyl acetate and 0.5 parts by weight of tert-butyl peroxyethylhexanoate. Subsequently, the resultant reaction mixture was held at 110° C. for one hour. Thereafter, at 80° C., the solution was adjusted to a solids content of 65% by weight using butyl acetate. The resultant solution had a viscosity of 15 dPas. The hydroxyl number of the methacrylate copolymer-was 120 mg KOH/g.

### Preparation Example 2

The Preparation of a Polyester-Methacrylate Copolymer Graft Copolymer (A1)

A polycondensation reactor equipped with stirrer, steam-heated column and a water separator was charged with 796 parts by weight of trimethylolpropane, 540 parts by weight of isononanoic acid, 821 parts by weight of phthalic anhydride and 83 parts by weight of xylene and this initial charge was slowly heated. Condensation was carried out at temperatures of not more than 190° C. to an acid number of 5 mg KOH/g and a viscosity of 8.0 dPas (60 percent strength in xylene). Subsequently, the reaction mixture was cooled and at 130° C. was partially dissolved with 910 parts by weight of Shellsol®A. The solution of the polyester was cooled to room temperature. It had a solids content of 66.5% by weight, an acid number of 5 mg KOH/g and a viscosity of 70 dPas (original).

To prepare the polyester-methacrylate copolymer graft copolymer, a stainless steel reactor equipped with stirrer, reflux condenser, a monomer feed and an initiator feed was charged with 700 parts by weight of the solution of the polyester and 70 parts by weight of VEOVA®10 (vinyl ester of Versatic® acid) and this initial charge was heated to 165° C. At this temperature, a monomer mixture of 350 parts by weight of styrene, 155 parts by weight of butanediol monoacrylate and 125 parts by weight of methyl methacrylate was metered into the initial charge at a uniform rate over the course of four hours and an initiator solution of 14 parts by weight of di-tert-butyl peroxide, 44 parts by weight of Shellsol A and 25 parts by weight of xylene was metered into the initial charge at a uniform rate over the course of five hours. Both feed streams were commenced simultaneously. After the end of the feed streams, polymerization was continued at 165° C. for two hours more. The temperature of the solution of the graft copolymer was subsequently lowered to 120° C. The solution was diluted with butyl acetate, giving a solids content of 65% by weight. The diluted solution was admixed with 5 parts by weight of benzoic acid.

The graft copolymer solution had an acid number of 5.3 mg KOH/g, a hydroxyl number of 90 mg KOH/g and a viscosity of 2.3 dPas (55 percent in butyl acetate).

### Example 1

The Preparation of a Coating Material System of the Invention and its use to Produce a Multicoat Color and Effect Coating System

For the preparation of the multicomponent surfacer, of the multicomponent topcoat material and of the dual-cure clearcoat material, the same diluent (C) (solvent mixture of xylene, Solventnaphtha, mineral spirit 135/180, methoxypropyl acetate, butyl acetate, butyl glycol acetate, ethyl ethoxypropionate and dipentenes) was used in each case.

For the preparation of the multicomponent surfacer, components (A), (B) and (C) were mixed with one another in a volume ratio of 4:1:1.

In the case of the multicomponent topcoat material, components (A) and (B) were mixed with one another in a volume ratio of 4:1, after which the resultant mixture was diluted with 10%, based on (A) and (B), of the diluent (C).

In the case of the dual-cure clearcoat material, components (A) and (B) were mixed with one another in a volume ratio of 2:1, after which the resultant mixture was diluted with 10%, based on (A) and (B), of the diluent (C).

TABLE 1
The material composition of components (A)
and (B) of the coating materials of the
coating material system of the invention

| | | Topcoat material | Clearcoat |
|---|---|---|---|
| Constituent | Surfacer | (one-shot topcoat) | material |
| Component (A): | | | |
| Synthalat ® A200^{a)} | 23 | — | — |
| Nitrocellulose | 5 | — | — |
| wool | | | |
| Graft copolymer of | — | 77 | — |
| preparation | | | |
| example 2 | | | |
| Methacrylate | — | — | 30 |
| copolymer of | | | |
| preparation | | | |
| example 1 | | | |
| Rahn ® 99-664^{b)} | — | — | 43 |
| Butyl acetate | 20 | 7.2 | 6.8 |
| Ethyl | — | — | 15 |
| ethoxypropionate | | | |
| Commercially | 27 | 12 | — |
| customary pigments | | | |
| Commercially | 24 | — | — |
| customary fillers | | | |
| Byk ® 325^{c)} | — | — | 0.3 |
| Byk ® 358^{c)} | — | 0.3 | 0.7 |
| Byk ® P104S^{d)} | 0.7 | — | — |
| Disperbyk ® 161^{d)} | — | 2.0 | — |
| Bentone ® 34^{e)} | — | 0.3 | — |
| Aerosil ®380^{e)} | — | 0.2 | — |
| Dibutyltin | 0.3 | 0.3 | 0.5 |
| dilaurate (10% in | | | |
| butyl acetate) | | | |
| Tinuvin ® 292^{f)} | — | 0.5 | 1.0 |
| Tinuvin ® 1130^{f)} | — | 0.2 | — |
| Tinuvin ® 400^{f)} | — | — | 1.0 |
| Irgacure ® 184^{g)} | — | — | 1.2 |
| Lucirin ® TPO^{g)} | — | — | 0.5 |
| Component (B): | | | |
| Desmodur ® N3600^{h)} | 56 | 56 | 56 |
| Methoxypropyl | 22 | 22 | 22 |
| acetate | | | |
| Ethyl | 22 | 22 | 22 |
| ethoxypropionate | | | |

a) commercially customary epoxy-acrylate resin from Synthopol Chemie; hydroxyl number: 200 mg KOH/g; solids content: 70 to 72% by weight;

b) commercially customary urethane acrylate from Rahn; hydroxyl number: 120 mg KOH/g; acrylate functionality: 3;

c) commercially customary leveling agents from Byk Chemie;

d) commercially customary wetting agents and dispersing aids from Byk Chemie;

e) Theological assistant;

f) commercially customary light stabilizers;

g) commercially customary photoinitiators;

h) commercially customary polyisocyanate based on hexamethylene diisocyanate, from Bayer AG;

To produce the multicoat color coating system, sanded steel panels were first of all coated with the surfacer. The surfacer was applied in two spray passes, dried at 60° C. for 30 minutes and then sanded. Subsequently, the one-shot topcoat material was applied in two spray passes, flashed off for 30 minutes and dried at 60° C.

Subsequently, the clearcoat material was applied in two spray passes with a flash-off time of 2.5 minutes inbetween. The applied clearcoat film was flashed off for 5 minutes, dried at 60° C. for 15 minutes and then cured using UV radiation with a dose of 1500 mJ/cm². The resultant clearcoat had a film thickness of from 50 to 60 μm.

The appearance of the multicoat coating system of the invention was excellent.

In a second test series, the cure behavior of the coating material system in shadow zones of substrates was simulated by not curing the above-described test panels with UV radiation. Nevertheless, the resultant clearcoat was not tacky but instead had a good initial hardness.

What is claim d is:

1. An integrated coating material system for producing multicoat color and/or effect coating systems on primed and unprimed substrates, comprising
(I) at least one multicomponent surfacer, comprising at least one component (A) comprising at least one constituent (A1) containing isocyanate-reactive groups and at least one filler, at least one component (B) comprising at least one polyisocyanate (B1) and a diluent (C), for producing at least one surfacer coat or antistonechip primer,
(II) at least one multicomponent topcoat material comprising at least one component (A) comprising at least one constituent (A1) containing isocyanate-reactive groups and at least one color pigment, at least one component (B) comprising at least one polyisocyanate (B1), and a diluent (C), for producing at least one solid-color topcoat, and
(III) at least one multicomponent clearcoat material comprising at least one component (A) comprising at least one constituent (A1) containing isocyanate-reactive groups, at least one component (B) comprising at least one polyisocyanate (B1), and a diluent (C),
the same polyisocyanate and the same diluent being used throughout for producing the multicomponent coating materials (I) to (III), wherein said clearcoat material (III) comprises a solvent-containing multicomponent system curable thermally and with actinic radiation (dual cure) and comprising
(A) at least one component comprising
(A1) at least one constituent containing at least 1.8 meq/g of isocyanate-reactive functional groups,
(A2) at least one constituent containing at least 1.8 meq/g of isocyanate-reactive functional groups and at least one functional group having at least one bond which can be activated with actinic radiation,
(B) at least one component comprising at least one polyisocyanate (B1), and
(C) a diluent.

2. The system as claimed in claim 1, wherein said bonds which can be activated with actinic radiation comprise carbon-hydrogen single bonds or carbon-carbon, carbon-oxygen, carbon-nitrogen, carbon-phosphorus or carbon-silicon single bonds or double bonds.

3. The system as claimed in claim 2, wherein carbon-carbon double bonds (“double bonds”) are used.

4. The system as claimed in claim 3, wherein the double bonds are present as (meth)acrylate, ethacrylate, crotonate, cinnamate, vinyl ether, vinyl ester, ethenylarylene, dicyclopentadienyl, norbornenyl, isoprenyl, isopropenyl, allyl or butenyl groups; ethenylarylene ether, dicyclopentadienyl ether, norbornenyl ether, isoprenyl ether, isopropenyl ether, allyl ether or butenyl ether groups; or ethenylarylene ester, dicyclopentadienyl ester, norbornenyl ester, isoprenyl ester, isopropenyl ester, allyl ester or butenyl ester groups.

5. The system as claimed in any of claims 1 to 4, wherein the isocyanate-reactive functional groups are thiol, primary or secondary amino, imino or hydroxyl groups.

6. The system as claimed in any of claims 1 to 5, wherein constituent (A1) comprises oligomeric or polymeric, random, alternating and/or block linear and/or branched and/or comb (co)polymers of ethylenically unsaturated monomers, or comprises polyaddition resins and/or polycondensation resins.

7. The system as claimed in any of claims 1 to 6, wherein constituent (A2) contains on average three functional groups having at least one bond which can be activated with actinic radiation per molecule.

8. The system as claimed in any of claims 1 to 7, wherein constituent (A2) comprises oligomeric or polymeric, random, alternating and/or block linear and/or branched and/or comb (co)polymers of ethylenically unsaturated monomers, or comprises polyaddition resins and/or polycondensation resins.

9. The system as claimed in any of claims 1 to 8, wherein component (A) and/or component (B) comprise(s) at least one reactive diluent which is curable with actinic radiation.

10. The system as claimed in claim 9, wherein the reactive diluent curable with actinic radiation contains in the molecule at least 5 bonds which can be activated with actinic radiation.

11. The system as claimed in any of claims 1 to 10, wherein the diluent (C) comprises at least two organic solvents.

12. The system as claimed in claim 11, wherein the diluent (C) comprises at least six organic solvents.

13. The use of the system as claimed in any of claims 1 to 12 for automotive OEM finishing, automotive refinishing, the coating of furniture, doors, windows or constructions in the interior and exterior sector and also for industrial coating, including coil coating, container coating, and the coating or impregnation of electrical components.
